(19) United States
(12) Patent Application Publication
(10) Pub. No.: US 2025/0079589 A1
(43) Pub. Date: Mar. 6, 2025

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/613,445

(22) Filed: Mar. 22, 2024

(30) Foreign Application Priority Data
Aug. 29, 2023 (JP) 2023-139164

(51) Int. Cl. H01M 50/186; H01M 10/04; H01M 50/107; H01M 50/179; H01M 50/198; H01M 50/342

(52) U.S. Cl. CPC H01M 50/186; H01M 10/0431; H01M 50/107; H01M 50/179; H01M 50/198; H01M 50/342; H01M 2200/20

(57) ABSTRACT

The power storage cell includes a wound electrode body, a case, an internal gasket (a seal member), a positive electrode terminal (an external terminal), and a positive electrode connecting portion (a connecting member). The case includes a peripheral wall portion, a lower lid (first lid portion), and an upper lid (second lid portion). The lower lid has an exhaust valve for exhausting the gas in the case. A through hole (second through hole) is formed in the upper lid (second lid). The positive electrode connecting portion includes a columnar portion extending in the Z direction so as to penetrate the through hole of the upper lid and the through hole (first through hole) of the inner gasket. The inner gasket is disposed so as to cover the through hole from the inside of the case.

### CROSS-REFERENCE TO RELATED APPLICATION

This application claims priority to Japanese Patent Application No. 2023-139164 filed on Aug. 29, 2023, incorporated herein by reference in its entirety.

### BACKGROUND

### 1. Technical Field

The present disclosure relates to a power storage cell.

### 2. Description of Related Art

WO2022/065211 discloses a cylindrical battery provided with a can bottom valve that opens when the internal pressure of an outer can increases.

### SUMMARY

In a conventional power storage cell such as that described in WO2022/065211, an exhaust gas may be discharged (leaked) from the side opposite to the side on which the can bottom valve is provided. In this case, the exhaust gas is not efficiently discharged from the can bottom valve (exhaust valve).

The present disclosure has been made in order to address the above issue, and an object thereof is to provide a power storage cell capable of efficiently discharging an exhaust gas from an exhaust valve.

An aspect of the present disclosure provides a power storage cell including:
a wound electrode body that includes a first electrode and a second electrode;
a case that houses the wound electrode body;
a seal member housed in the case and having a first through hole;
an external terminal; and
a connecting member that electrically connects the external terminal and the first electrode.
   The case includes
a peripheral wall portion disposed on an outer peripheral side of the wound electrode body and extending in a cylindrical shape along an axial direction of the wound electrode body,
a first lid portion that closes one end of the peripheral wall portion in the axial direction, and a second lid portion that closes the other end of the peripheral wall portion in the axial direction.
   The first lid portion includes an exhaust valve for discharging a gas in the case.
   The second lid portion has a second through hole through which an inside of the case communicates with an outside of the case.
   The connecting member includes a columnar portion that extends in the axial direction so as to penetrate the second through hole of the second lid portion and the first through hole of the seal member.
   The seal member is disposed so as to cover the second through hole from the inside of the case.

In the power storage cell according to the aspect of the present disclosure, as described above, the first lid portion is provided with the exhaust valve, and the second through hole of the second lid portion is covered by the seal member from the inside of the case. Accordingly, the seal member suppresses the exhaust gas generated from the wound electrode body being leaked from the second lid portion side to the outside of the case. Accordingly, the exhaust gas can be efficiently discharged from the exhaust valve of the first lid portion.

In the power storage cell according to the above aspect, preferably, the connecting member further includes a plate-shaped portion connected to the columnar portion inside the case.

The plate-shaped portion may be disposed so as to extend across the axial direction on a side opposite of the external terminal from the seal member.
With such a configuration, the plate-shaped portion can be easily disposed on the inner side of the case (on the wound electrode body side) with respect to the sealing member. As a result, the plate-shaped portion and the first electrode can be easily electrically connected in the case.

In this case, preferably,
the seal member is sandwiched between the second lid portion and the plate-shaped portion in the axial direction.
   With such a configuration, it is possible to suppress a gap being formed between the seal member and each of the second lid portion and the plate-shaped portion. As a result, it is possible to suppress the exhaust gas being leaked from the second lid portion side to the outside of the case.

Preferably, the power storage cell according to the above aspect further includes
an insulating member disposed so as to cover the second through hole of the second lid portion from the outside of the case.
   The second lid portion may be electrically connected to the second electrode.
   The insulating member may be configured to
have a third through hole through which the columnar portion penetrates, and
be disposed so as to insulate the second lid portion and the external terminal.
   With such a configuration, the second through hole is covered by the insulating member, and thus it is possible to suppress the exhaust gas being leaked from the second through hole to the outside of the case. In addition, since the third through hole is provided in the insulating member, the columnar portion can be introduced into the inside of the case while the insulating member is insulating the second lid portion and the external terminal.

In this case,
a thickness of the seal member in the axial direction may be greater than a thickness of the insulating member in the axial direction.
   With such a configuration, the gap (space) in the case can be easily filled by the seal member compared to when the thickness of the seal member is equal to or less than the thickness of the insulating member. As a result, it is possible to suppress the exhaust gas being leaked from the seal member side to the outside of the case.

According to the present disclosure, an exhaust gas can be efficiently discharged from an exhaust valve provided in a case of a power storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a configuration of a power storage cell according to an embodiment;

FIG. 2 is a cross-sectional Z1 view of the top cover according to one embodiment;

FIG. 3 is a plan view of the lower lid from Z2 side according to an embodiment;

FIG. 4 is a schematic perspective view illustrating a configuration of a wound electrode body according to an embodiment;

FIG. 5 is a plan view illustrating a configuration of a positive electrode current collector plate according to an embodiment;

FIG. 6 is a plan view illustrating a configuration of a negative electrode current collector plate according to an embodiment;

FIG. 7 is a partially enlarged view of the vicinity of the positive electrode current collector plate of FIG. 1;

FIG. 8 is a partially enlarged view of the vicinity of the negative electrode current collector plate of FIG. 1; and

FIG. 9 is a cross-sectional view of the top cover according to one embodiment as viewed from a Z2 side.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

The power storage cell 100 includes a wound electrode body 1, a case 2, a positive electrode terminal 3, a positive electrode connecting portion 4, an external gasket 5, an internal gasket 6, and a negative electrode current collector plate 7. Each of the external gasket 5 and the internal gasket 6 has an insulating property. The positive electrode terminal 3 and the internal gasket 6 are examples of the “external terminal” and the “seal member” of the present disclosure, respectively. The external gasket 5 and the positive electrode connecting portion 4 are examples of the “insulating member” and the “connecting member” of the present disclosure, respectively.

The wound electrode body 1 is accommodated in the case 2. The case 2 includes an upper lid 2a, a lower lid 2b, and a peripheral wall portion 2c. The peripheral wall portion 2c is disposed on the outer periphery of the wound electrode body 1. The peripheral wall portion 2c extends in a cylindrical shape along the axial direction (Z direction) of the wound electrode body 1. That is, the case 2 has a cylindrical shape. The wound electrode body 1 is wound so as to have a cylindrical shape in the same manner as the case 2. That is, the power storage cell 100 is a cylindrical battery. The case 2 is made of copper, aluminum, or the like. Further, the upper lid 2a and the lower lid 2b are exemplary of the “second lid portion” and the “first lid portion”, respectively. The Z direction is an example of the “axial direction” of the present disclosure.

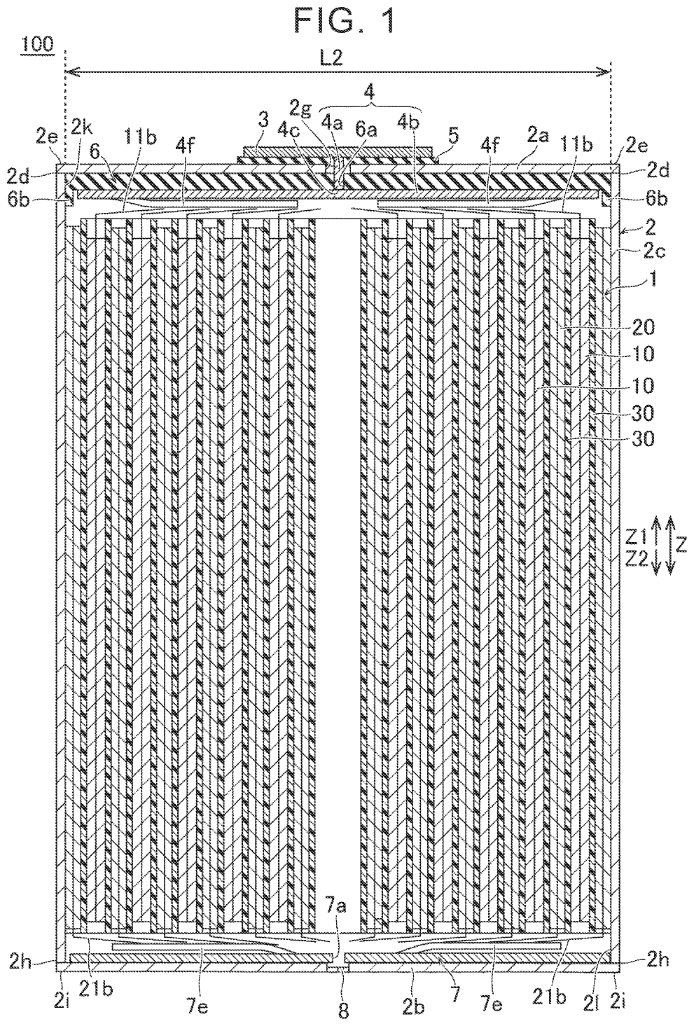

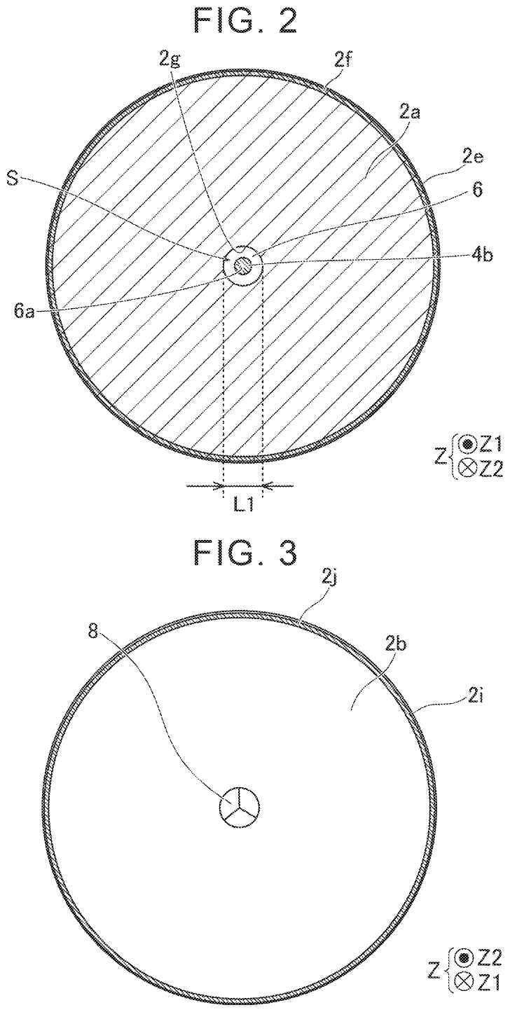

The upper lid 2a closes the opening 2k on Z1 side of the peripheral wall portion 2c. Specifically, the outer peripheral edge 2e of the upper lid 2a is welded to Z1 end 2d of the peripheral wall portion 2c. The welded portion 2f between the upper lid 2a and the peripheral wall portion 2c (see the hatched portion in FIG. 2) is formed in an annular shape along the outer peripheral edge 2e. The welded portion 2f is formed, for example, by irradiating the laser from Z1 toward a part of the upper lid 2a (the vicinity of the outer peripheral edge 2e) corresponding to the end 2d. In FIG. 1, the welded portion 2f is omitted for the sake of simplicity. In addition, the opening 2k is an exemplary “other end” of the present disclosure.

The upper lid 2a has a through hole 2g that communicates the inside and the outside of the case 2. The through hole 2g is formed in the center of the upper lid 2a. The through hole 2g has a circular shape when viewed from Z1 (see FIG. 2). The through hole 2g has a length L1 (see FIG. 2). Note that the through hole 2g is an exemplary “second through hole” disclosed herein.

The lower lid 2b closes Z2 opening 2l of the peripheral wall portion 2c. Specifically, the outer peripheral edge 2i of the lower lid 2b is welded to Z2 end 2h of the peripheral wall portion 2c. Thus, the welded portion 2j between the lower lid 2b and the peripheral wall portion 2c (see the hatched portion in FIG. 3) is formed in an annular shape along the outer peripheral edge 2i. The welded portion 2j is formed, for example, by irradiating the laser from Z2 toward a part of the lower lid 2b (the vicinity of the outer peripheral edge 2i) corresponding to the end 2h. In FIG. 1, the welded portion 2j is omitted for the sake of simplicity. In addition, the opening 2l is an exemplary “one end” of the present disclosure.

The lower lid 2b has an exhaust valve 8 for exhausting the gases in the case 2. The exhaust valve 8 is configured to discharge gas from the case 2 when the internal pressure of the case 2 becomes equal to or higher than a predetermined threshold value. The exhaust valve 8 is provided at the center of the lower lid 2b (see FIG. 3).

The wound electrode body 1 includes a positive electrode sheet 10, a negative electrode sheet 20, and a separator 30. The separator 30 is provided between the positive electrode sheet 10 and the negative electrode sheet 20. The separator 30 separates the positive electrode sheet 10 and the negative electrode sheet 20 from each other while allowing ions (for example, lithium ions) to move back and forth between the positive electrode sheet 10 (positive electrode active material) and the negative electrode sheet 20 (negative electrode active material). The wound electrode body 1 includes an electrode plate group in which a positive electrode sheet 10 and a negative electrode sheet 20 are wound with a separator 30 interposed therebetween. The positive electrode sheet 10 and the negative electrode sheet 20 are examples of the “first electrode” and the “second electrode” of the present disclosure, respectively.

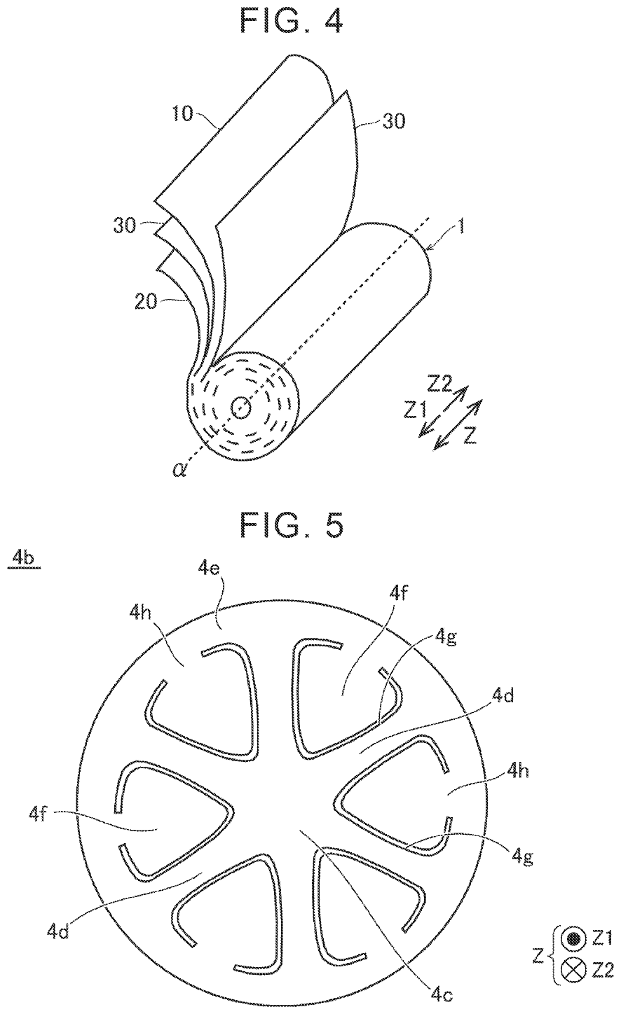

As shown in FIG. 4, the wound electrode body 1 is wound such that the positive electrode sheet 10, the negative electrode sheet 20, and the separator 30 surround the winding axis a. The wound electrode body 1 is formed by winding an electrode sheet in which the negative electrode sheet 20, the separator 30, the positive electrode sheet 10, and the separator 30 are stacked in this order from the outer peripheral side around the winding axis a. In FIG. 4, a state in which the winding of the wound electrode body 1 is slightly unwound is illustrated so that the winding state of the wound electrode body 1 can be easily understood.

Referring again to FIG. 1, the positive electrode terminal 3 is exposed by being provided outside the case 2. The positive electrode terminal 3 is made of aluminum. The positive electrode terminal 3 is provided on Z1 face of the external gasket 5 disposed on the upper lid 2a of the case 2.

The positive electrode connecting portion 4 includes a columnar portion 4a and a positive electrode current collector plate 4b. The columnar portion 4a is connected to the positive electrode terminal 3. The columnar portion 4a is provided so as to extend along the Z-direction. The columnar portion 4a connects the positive electrode terminal 3 and the positive electrode current collector plate 4b. The columnar portion 4a extends from the positive electrode terminal 3 to the inside of the case 2 through the through hole 2g of the upper lid 2a. Note that the positive electrode current collector plate 4b is an exemplary “plate-shaped portion” disclosed herein.

The positive electrode current collector plate 4b is accommodated in the case 2. The positive electrode current collector plate 4b is welded to Z2 end 4c of the columnar portion 4a.

The positive electrode current collector plate 4b is disposed so as to intersect (orthogonally) the positive electrode terminal 3 with respect to the internal gasket 6 in the Z-direction on the other side (Z2 side). Specifically, the positive electrode current collector plate 4b is disposed so as to be in close contact with Z2 face of the internal gasket 6.

The external gasket 5 is provided outside the case 2. Specifically, the external gasket 5 is sandwiched between the positive electrode terminal 3 and the upper lid 2a of the case 2. Thus, the positive electrode terminal 3 and the case 2 (upper lid 2a) are insulated from each other.

A through hole 5a (see FIG. 7) is formed in the external gasket 5. The columnar portion 4a extends from the positive electrode terminal 3 to the positive electrode current collector plate 4b through the through hole 5a. The through hole 5a is an exemplary “third through hole” of the present disclosure.

The internal gasket 6 is provided inside the case 2. Specifically, the internal gasket 6 is disposed between the upper lid 2a of the case 2 and the positive electrode current collector plate 4b. Thus, the upper lid 2a of the case 2 and the positive electrode current collector plate 4b are insulated from each other.

A through hole 6a is formed in the internal gasket 6. The through hole 6a is provided at the center of the internal gasket 6 when viewed along the Z-direction. The columnar portion 4a extends from the positive electrode terminal 3 to the positive electrode current collector plate 4b through the through hole 6a.

The internal gasket 6 also includes a protrusion 6b. The protrusion 6b protrudes Z2 from the outer peripheral edge of the internal gasket 6. The protrusion 6b is provided so as to shield the positive electrode current collector plate 4b and the peripheral wall portion 2c. Thus, the positive electrode current collector plate 4b and the peripheral wall portion 2c are insulated from each other. The through hole 6a is an exemplary “first through-hole” of the present disclosure.

The negative electrode current collector plate 7 is housed in the case 2. The negative electrode current collector plate 7 is welded to a negative electrode uncoated portion 21b, which will be described later, of the negative electrode sheet 20. The negative electrode current collector plate 7 contacts the lower lid 2b of the case 2.

A through hole 7a is formed in the negative electrode current collector plate 7. The through hole 7a is provided at a position overlapping the exhaust valve 8 in the Z-direction. As a result, the exhaust gases can be easily guided to the exhaust valve 8 through the through hole 7a.

FIG. 5 is a plan view of the positive electrode current collector plate 4b. The positive electrode current collector plate 4b has a disk-shape. The positive electrode current collector plate 4b includes a central portion 4c, a spoke 4d, an outer peripheral edge portion 4e, and a piece portion 4f.

The central portion 4c is provided at the center of the positive electrode current collector plate 4b. The columnar portion 4a is joined to the central portion 4c. The spoke 4d is provided so as to extend radially outward from the central portion 4c. Six spokes 4d are provided at equal angular intervals around the central portion 4c of the positive electrode current collector plate 4b.

The outer peripheral edge portion 4e is provided on the outer peripheral edge of the positive electrode current collector plate 4b. Each of the six spokes 4d connects the outer peripheral edge portion 4e and the central portion 4c. The spoke 4d is formed to bend in the Z-direction. The central portion 4c of the positive electrode current collector plate 4b is largest in the Z-direction.

Through holes 4g are formed between circumferentially adjacent spokes 4d. That is, six through holes 4g are formed. A piece portion 4f is provided inside each of the six through hole 4g. Each of the six piece portions 4f is connected to the outer peripheral edge portion 4e by the connecting portion 4h. Each of the six piece portions 4f is welded to the positive electrode current collector plate 4b. Note that each of the six piece portions 4f has a tapered shape toward the radially inner side.

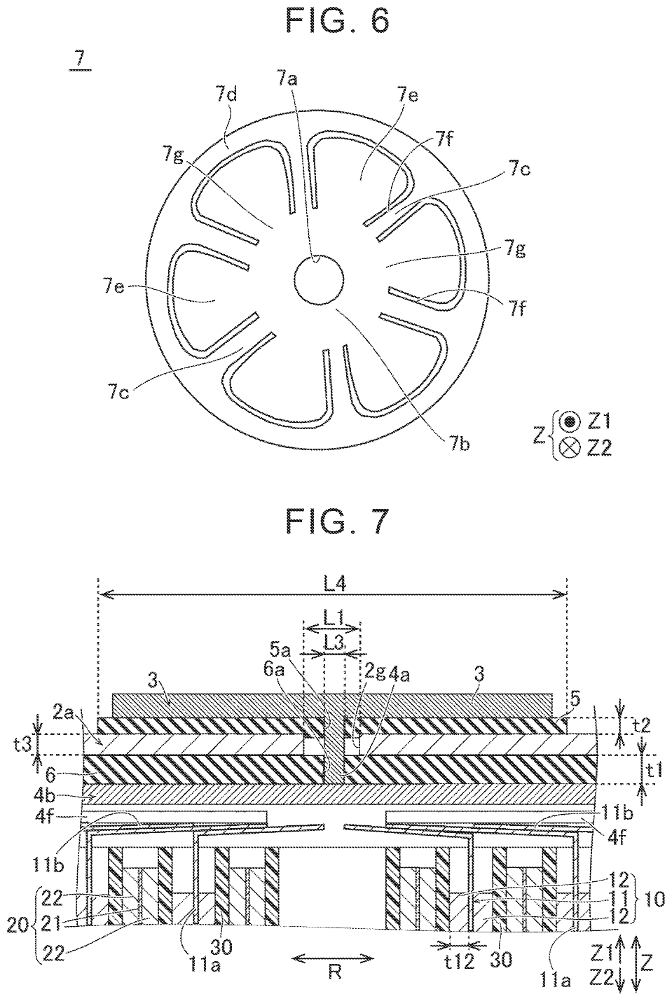

FIG. 6 is a plan view of the negative electrode current collector plate 7. The negative electrode current collector plate 7 has a disk shape. The negative electrode current collector plate 7 includes a central portion 7b, a spoke 7c, an outer peripheral edge portion 7d, and a piece portion 7c.

The central portion 7b is provided at the center of the negative electrode current collector plate 7. The spoke 7c is provided so as to extend radially outward from the central portion 7b. The through hole 7a is provided in the central portion 7b. Six spoke 7c are provided at equal angular intervals around the central portion 7b of the negative electrode current collector plate 7.

The outer peripheral edge portion 7d is provided on the outer peripheral edge of the negative electrode current collector plate 7. Each of the six spoke 7c connects the outer peripheral edge portion 7d and the central portion 7b. The spoke 7c are formed so as to bend in the Z-direction. The outer peripheral edge portion 7d of the negative electrode current collector plate 7 largest moves (displaces) in the Z-direction.

Through holes 7f are formed between circumferentially adjacent spoked 7c. That is, six through holes 7f are formed. A piece portion 7e is provided inside each of the six through hole 7f. Each of the six piece portions 7e is connected to the outer peripheral edge portion 7d by the connecting portion 7g. Each of the six piece portions 7e is welded to the negative electrode current collector plate 7. Note that each of the six piece portions 7e has a tapered shape toward the radially inner side.

As illustrated in FIG. 7, the positive electrode sheet 10 includes a positive electrode current collector 11 and a positive electrode mixture layer 12. The positive electrode current collector 11 includes a positive electrode coated portion 11a and a positive electrode uncoated portion 11b. The positive electrode coated portion 11a is a portion of the positive electrode current collector 11 on which the positive electrode mixture layers 12 are coated. The positive electrode uncoated portion 11b is a portion (exposed portion) of the positive electrode current collector 11 on which the positive electrode mixture layers 12 are not coated. The positive electrode mixture layers 12 are coated on both surfaces of the positive electrode coated portion 11a in the radial direction (R direction).

The positive electrode uncoated portion 11b is located Z1 the positive electrode coated portion 11a. Specifically, the positive electrode uncoated portion 11b protrudes Z1 from the positive electrode coated portion 11a. The positive electrode mixture layer 12 is in close contact with the separator 30.

The positive electrode current collector 11 is made of, for example, aluminum. The positive electrode mixture layer 12 is formed by coating a positive electrode slurry on the surface of the positive electrode current collector 11 and drying the slurry. The positive electrode slurry is a slurry prepared by kneading a material (a positive electrode active material, a binder, or the like) of the positive electrode mixture layer 12 and a solvent. The positive electrode mixture layer 12 is in close contact with the separator 30. The thickness t12 of the positive electrode mixture layers 12 is, for example, 0.1 μm or more and 1000 μm or less.

The positive electrode uncoated portion 11b is bent radially inward by being in contact with the positive electrode current collector plate 4b disposed on Z1 side. The positive electrode current collector plate 4b is positively charged by being contacted with the positive electrode uncoated portion 11b. The positive electrode uncoated portion 11b is welded to the positive electrode current collector plate 4b. As a result, the positive electrode current collector plate 4b is positively charged. In addition, the positive electrode terminal 3 electrically connected to the positive electrode current collector plate 4b by the columnar portion 4a is positively charged. That is, the positive electrode terminal 3 and the positive electrode sheet 10 are electrically connected by the positive electrode connecting portion 4.

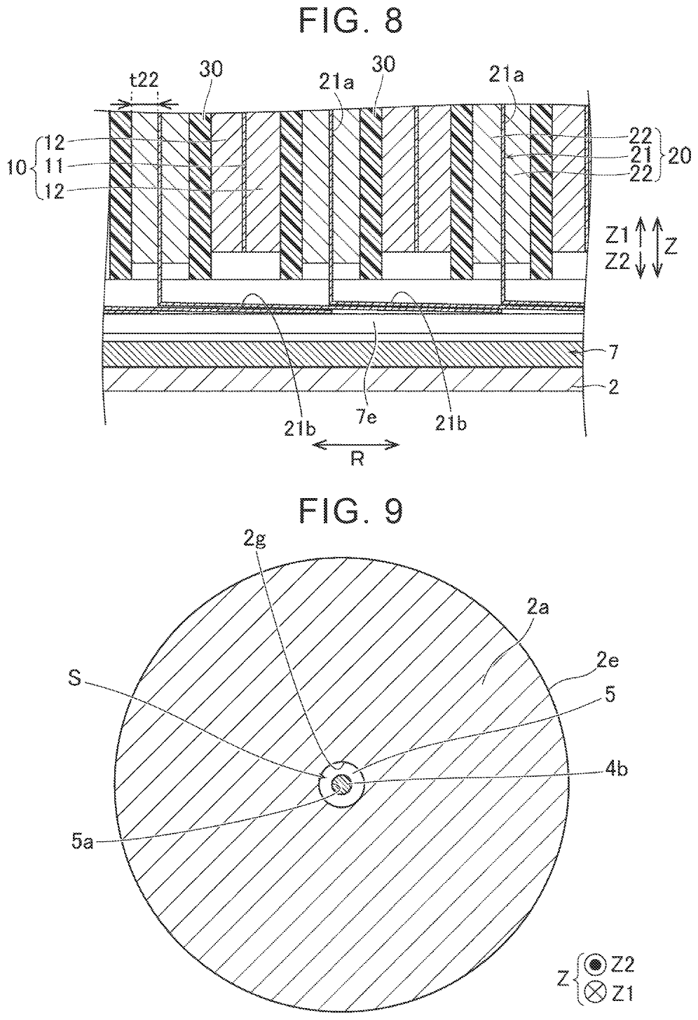

As illustrated in FIG. 8, the negative electrode sheet 20 includes a negative electrode current collector 21 and a negative electrode mixture layer 22. The negative electrode current collector 21 includes a negative electrode coated portion 21a and a negative electrode uncoated portion 21b. The negative electrode coated portion 21a is a portion of the negative electrode current collector 21 on which the negative electrode mixture layers 22 are coated. The negative electrode uncoated portion 21b is a portion (exposed portion) of the negative electrode current collector 21 on which the negative electrode mixture layers 22 are not coated. The negative electrode mixture layers 22 are coated on both surfaces of the negative electrode coated portion 21a in the radial direction (R direction).

The negative electrode uncoated portion 21b is located Z2 the negative electrode coated portion 21a. Specifically, the negative electrode uncoated portion 21b protrudes Z2 from the negative electrode coated portion 21a. The negative electrode mixture layer 22 is in close contact with the separator 30.

The negative electrode current collector 21 is made of, for example, copper. The negative electrode mixture layer 22 is formed by coating a negative electrode slurry on the surface of the negative electrode current collector 21 and drying the negative electrode slurry. The negative electrode slurry is a slurry prepared by kneading a material (a negative electrode active material, a binder, or the like) of the negative electrode mixture layer 22 and a solvent. The thickness t22 of the negative electrode mixture layers 22 is, for example, 0.1 μm or more and 1000 μm or less.

The negative electrode uncoated portion 21b is bent radially inward by being brought into contact with the negative electrode current collector plate 7 disposed Z2. The negative electrode current collector plate 7 is negatively charged by contacting the negative electrode uncoated portion 21b. As a result, the lower lid 2b contacting the negative electrode current collector plate 7 is negatively charged. That is, the negative electrode current collector plate 7 electrically connects the negative electrode sheet 20 and the lower lid 2b of the case 2. Further, since the lower lid 2b, the peripheral wall portion 2c, and the upper lid 2a are electrically connected to each other, each of the peripheral wall portion 2c and the upper lid 2a is negatively charged.

Here, in the conventional power storage cell, the exhaust gas is discharged (leaked) from the side opposite to the side where the exhaust valve is provided, so that the exhaust gas may not be efficiently discharged from the exhaust valve.

Therefore, in the present embodiment, as shown in FIG. 7, the internal gasket 6 is disposed so as to cover the through hole 2g from the inside of the case 2. Specifically, the internal gasket 6 is disposed so as to fill a gap S (see FIG. 2) formed between the through hole 2g and the columnar portion 4a when viewed from Z1.

The columnar portion 4a may be press-fitted into the through hole 6a of the internal gasket 6. That is, the outer peripheral surface of the columnar portion 4a and the inner peripheral surface of the through hole 6a may be in close contact with each other. Accordingly, since the columnar portion 4a plugs the through hole 6a, it is possible to suppress the exhaust gases from being discharged to the outside of the case 2 through the through hole 6a.

Further, although not shown, the internal gasket 6 has a disk shape when viewed along the Z direction. The internal gasket 6 has a length L2 (see FIG. 1). Further, the through hole 6a of the internal gasket 6 has a circular shape (see FIG. 2) as viewed along the Z-direction. The through hole 6a has a length L3. The through hole 5a of the external gasket 5 has the same configuration as the through hole 6a. That is, the through hole 5a has a length L3.

The internal gasket 6 is sandwiched between the upper lid 2a and the positive electrode current collector plate 4b in the Z-direction. That is, the internal gasket 6 is provided such that the surface of the internal gasket 6 on Z2 side is in close contact with the positive electrode current collector plate 4b as described above, and the surface of the internal gasket 6 on Z1 side is in close contact with the upper lid 2a. That is, no gap is formed between the internal gasket 6 and the positive electrode current collector plate 4b and between the internal gasket 6 and the upper lid 2a.

The internal gasket 6 may be formed of a resin or the like having elasticity. The internal gasket 6 may be elastically deformed by being pressed by the upper lid 2a and the positive electrode current collector plate 4b in the Z-direction.

The internal gasket 6 has a thickness t1 in the Z-direction. The external gasket 5 has a thickness t2 in the Z-direction. The minimum value of the thickness t1 of the internal gasket 6 is larger than the maximum value of the thickness t2 of the external gasket 5. Further, the minimum value of the thickness t1 of the internal gasket 6 is larger than the maximum value of the thickness t3 of the upper lid 2a in the Z-direction.

The external gasket 5 is disposed so as to cover the through hole 2g of the upper lid 2a from the outer side of the case 2. Specifically, the external gasket 5 is disposed so as to fill a gap S (see FIG. 9) formed between the through hole 2g and the columnar portion 4a when viewed from Z2.

The columnar portion 4a may be press-fitted into the through hole 5a of the external gasket 5. That is, the outer peripheral surface of the columnar portion 4a and the inner peripheral surface of the through hole 5a may be in close contact with each other. Accordingly, since the columnar portion 4a plugs the through hole 5a, it is possible to suppress the exhaust gases from being discharged to the outside of the case 2 through the through hole 5a.

The external gasket 5 has a disk shape. The external gasket 5 has a length L4. The length L4 is larger than the length L1 of the through hole 2g of the upper lid 2a.

As described above, in the present embodiment, the internal gasket 6 is disposed so as to cover the through hole 2g on the upper lid 2a from the inside of the case 2. Accordingly, since the through hole 2g is blocked by the internal gasket 6 inside the case 2, it is possible to suppress the exhaust gas leaking from the through hole 2g to the outside of the case 2. As a result, the exhaust gas can be efficiently discharged from the exhaust valve 8.

In addition, as compared with cases where a case is formed by drawing a metallic plate or the like, the case 2 is formed using the upper lid 2a and the lower lid 2b, whereby the manufacturing process and the manufacturing device of the case 2 can be simplified.

In the above embodiment, the internal gasket 6 is sandwiched between the upper lid 2a and the positive electrode current collector plate 4b in the Z-direction. For example, a slight gap may be formed between the internal gasket 6 and the upper lid 2a.

In the above embodiment, the thickness t1 of the internal gasket 6 in the Z direction is larger than the thickness t2 of the external gasket 5 in the Z direction. The thickness t1 may be less than or equal to the thickness t2.

In the above embodiment, an example has been described in which the internal gasket (seal member) is provided in close contact with the positive electrode current collector plate (plate-like portion), but the present disclosure is not limited thereto. The inner gasket (seal member) may be provided in close contact with the negative electrode current collector plate (plate-like portion).

In the above embodiment, the upper lid 2a and the peripheral wall portion 2c and the lower lid 2b and the peripheral wall portion 2c are welded to each other. At least one of the above may be connected by crimping.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. A power storage cell comprising:
a wound electrode body that includes a first electrode and a second electrode;
a case that houses the wound electrode body;
a seal member housed in the case and having a first through hole;
an external terminal; and
a connecting member that electrically connects the external terminal and the first electrode, wherein:
the case includes
a peripheral wall portion disposed on an outer peripheral side of the wound electrode body and extending in a cylindrical shape along an axial direction of the wound electrode body,
a first lid portion that closes one end of the peripheral wall portion in the axial direction, and
a second lid portion that closes the other end of the peripheral wall portion in the axial direction;
the first lid portion includes an exhaust valve for discharging a gas in the case;
the second lid portion has a second through hole through which an inside of the case communicates with an outside of the case;
the connecting member includes a columnar portion that extends in the axial direction so as to penetrate the second through hole of the second lid portion and the first through hole of the seal member; and
the seal member is disposed so as to cover the second through hole from the inside of the case.

2. The power storage cell according to claim 1, wherein:
the connecting member further includes a plate-shaped portion connected to the columnar portion inside the case; and
the plate-shaped portion is disposed so as to extend across the axial direction on a side opposite of the external terminal from the seal member.

3. The power storage cell according to claim 2, wherein the seal member is sandwiched between the second lid portion and the plate-shaped portion in the axial direction.

4. The power storage cell according to claim 1, further comprising an insulating member disposed so as to cover the second through hole of the second lid portion from the outside of the case, wherein:
the second lid portion is electrically connected to the second electrode; and
the insulating member is configured to
have a third through hole through which the columnar portion penetrates, and
be disposed so as to insulate the second lid portion and the external terminal.

5. The power storage cell according to claim 4, wherein a thickness of the seal member in the axial direction is greater than a thickness of the insulating member in the axial direction.
